(19) United States
(12) Patent Application Publication
(10) Pub. No.: US 2012/0167181 A1
(43) Pub. Date: Jun. 28, 2012

(54) IMAGE FORMING APPARATUS, IMAGE FORMING METHOD AND IMAGE FORMING SYSTEM

(75) Inventors: Hiroshi Yamaguchi, Shizuoka-ken (JP); Toshiyuki Sato, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/308,634

(22) Filed: Dec. 1, 2011

Related U.S. Application Data
(60) Provisional application No. 61/426,007, filed on Dec. 22, 2010.

(51) Int. Cl. G06F 17/30

(52) U.S. Cl. 726/4

(57) ABSTRACT

According to one embodiment, an image forming apparatus which is connected to a server via a communication line includes a control section which obtains a user ID and a password for user authentication, receives a restriction condition which regulates a character string for which use as the password is prohibited and a form thereof from the server, determines whether or not the password input meets the restriction condition, and displays a screen which prompts a change in the password when the restriction condition is not met.

### CROSS-REFERENCE TO RELATED APPLICATIONS

This application is based upon and claims the benefit of U.S. Provisional Application No. 61/426,007, filed on Dec. 22, 2010.

### FIELD

Embodiments described herein relate generally to an image forming apparatus, an image forming method and an image forming system.

### BACKGROUND

Currently, IT managers in companies are managing the use and operation of IT equipment which is used in the company in order to increase security or maintain security. Due to this, an improvement in corporate governance is being achieved.

User authentication using an ID and password is used at many companies as the basis of maintaining security. There are prohibited characters, a minimum number of letters, and the like as password rules. There is also IT equipment which supports these rules, but currently, the level of support differs depending on the equipment.

The users of IT equipment tend to use simple passwords or passwords which relate to personal information. For example, it is typical that users use passwords which are obvious to the user and are not likely to be forgotten such as passwords which are a simple string of numbers, an English word which is easy to use on a PC (Personal Computer), or their own name, employee ID number, mail address or the like which relate to personal information. However, simple passwords or passwords which relate to personal information such as these are easily identified by other individuals and may also become the cause of information leaks.

On the other hand, IT managers manage passwords and the like according to company policy while operating peripheral devices such as an image forming apparatus. As a result, after the introduction of IT equipment and in the stage of operation, passwords are made stricter in compliance with company policy or the policy is set with regard to equipment to which it has not been applied. Accordingly, there is a demand to be able to flexibly support changes in passwords in IT equipment.

### BRIEF DESCRIPTION OF THE DRAWINGS

FIG. 1 is an exemplary diagram illustrating a configuration of an image forming system of a first embodiment.

FIG. 2 is an exemplary diagram illustrating a configuration of a control system of each device which configures the image forming system of the first embodiment.

FIG. 3 is an exemplary diagram illustrating content of a user DB of the first embodiment.

FIG. 4 is an exemplary flow diagram illustrating a sequence for changing and setting security information of the first embodiment.

FIG. 5 is an exemplary diagram illustrating a setting screen of security information of the first embodiment.

FIG. 6 is an exemplary diagram illustrating content of security information in a user DB of the first embodiment.

FIG. 7 is an exemplary flow diagram illustrating an initial authentication sequence after an update in security information in an image forming apparatus of the first embodiment.

FIG. 8 is an exemplary diagram illustrating an authentication input screen in the image forming apparatus of the first embodiment.

FIG. 9 is an exemplary diagram illustrating an authentication input screen in the image forming apparatus.

FIG. 10 is an exemplary diagram illustrating a skip condition setting screen of the first embodiment.

FIG. 11 is an exemplary flow diagram illustrating an authentication sequence of the second time and beyond after an update in security information in the image forming apparatus of the first embodiment.

FIG. 12 is an exemplary flow diagram illustrating an authentication sequence of the second time and beyond after an update in security information in the image forming apparatus of the first embodiment.

### DETAILED DESCRIPTION

In general, according to one embodiment, an image forming apparatus which is connected to a server via a communication line includes a control section which obtains a user ID and a password for user authentication, receives a restriction condition which regulates a character string and a form thereof for which use as the password is prohibited from the server, determines whether or not the password input meets the restriction condition, and displays a screen which prompts a change in the password when the restriction condition is not met.

### First Embodiment

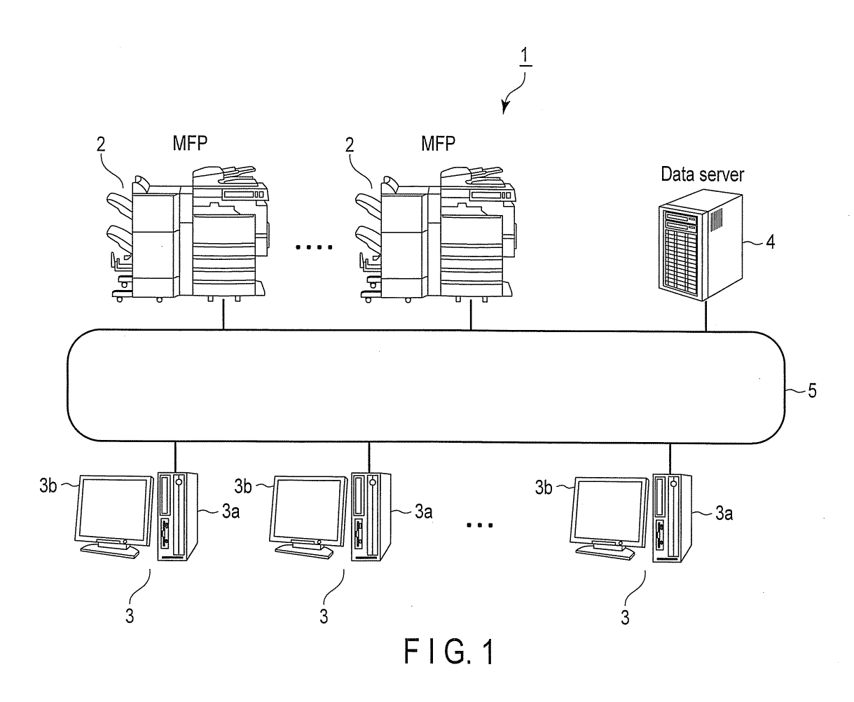

FIG. 1 is an exemplary diagram illustrating a configuration of an image forming system of the first embodiment.

An image forming system 1 is provided with at least one MFP 2, a client terminal 3, and a data server 4, and these are connected via a communication line 5.

The MFP 2 which is an image forming apparatus is a digital multifunction machine and is an apparatus which is provided with a plurality of functions such as a copier, a scanner, a facsimile machine, an image data recording device (BOX device), and the like in one unit. A control panel 2a and a communication device are provided in the MFP 2. A user inputs an instruction to the MFP 2 via various input keys and a display device which are provided in the control panel 2a. The communication device functions as an interface for performing reception and transmission of information via the communication line 5.

The client terminal 3 is an information processing terminal such as a PC which the user possesses. The client terminal 3 instructs various operations with regard to the MFP 2, for example, the execution of a printing job. In addition, the client terminal 3 instructs updating of data with regard to the data server 4. The client terminal 3 is provided with a control section 3a and a display section 3b. The control section 3a controls comprehensively the operation of the client terminal 3. The display section 3b displays information which is received and transmitted with the control section 3a.

The data server 4 holds information related to the user who uses the MFP 2 (user information) and control information which restricts use of passwords (security information). An IT manager is able to change the security information on the data server 4 from a predetermined client terminal 3. Here, it is possible to use an LDAP (Lightweight Directory Access Protocol) server as the data server.

The communication line 5 is not limited to communication which uses wiring such as conductive wiring, optical fibers, or the like but also includes wireless communication which uses light, sound waves, or electrical waves, or the like as a route which is widely used in the reception and transmission of information.

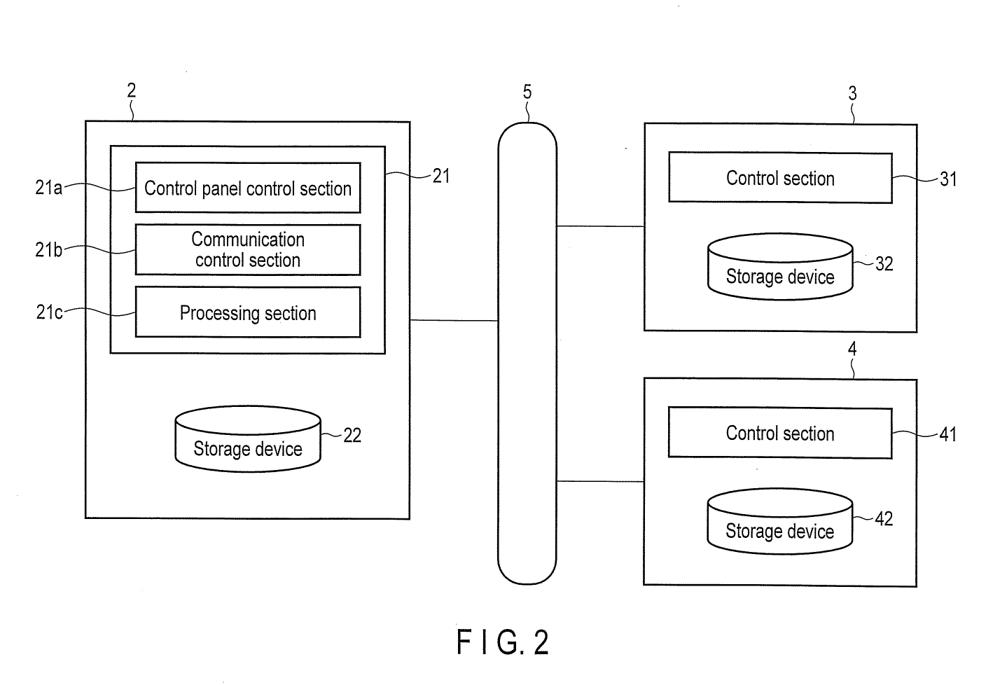

FIG. 2 is an exemplary diagram illustrating a configuration of a control system of each device which configures an image forming system of the first embodiment.

The MFP 2 has a control section 21 and a storage device 22. The control section 21 controls comprehensively the operation of the MFP 2. The storage device 22 is a storage medium which is disposed in an inner portion of the MFP 2. User authentication information, information on various setting values, and the like are stored in the storage device 22.

Then, a control panel control section 21a, a communication control section 21b, and a processing section 21c are provided in the control section 21. The control panel control section 21a controls the information reception and transmission operation with the control panel 2a. The communication control section 21b controls the reception and transmission of information between the client terminal 3 and the data server 4 via the communication line 5. The processing section 21c processes the operation of the MFP 2 and executes a process (which will be described later) which supports a security policy which is set by the IT manager.

The client terminal 3 has a control section 31 and a storage device 32. The control section 31 controls comprehensively the operation of the client terminal 3. The storage device 32 is a storage medium which is disposed in an inner portion of the client terminal 3. Information related to the user, an image file, and the like are stored in the storage device 32.

The data server 4 is provided with a control section 41 and a storage device 42. The control section 41 controls comprehensively the operation of the data server 4. The storage device 42 is a storage medium which is disposed in an inner portion of the data server 4. User information 44a, security information 44b, and the like are stored in the storage device 42 as a user DB (Data Base).

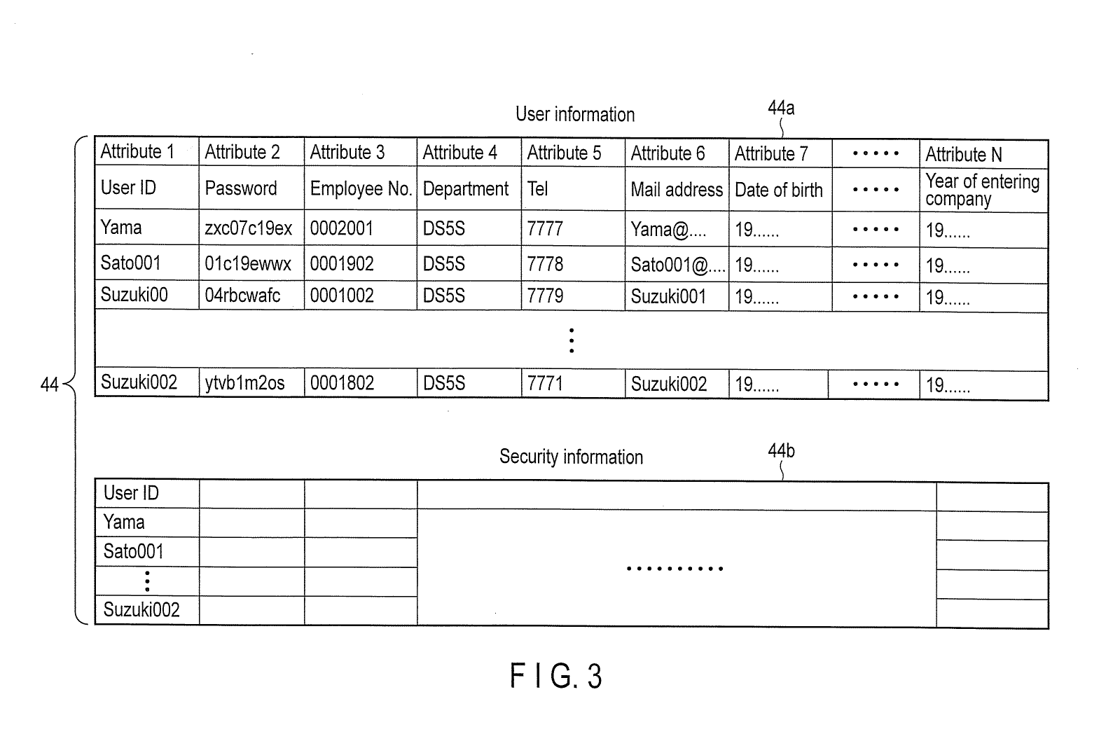

FIG. 3 is an exemplary diagram illustrating content of the user DB 44 of the first embodiment.

The user DB 44 includes the user information 44a and the security information 44b for each user. The user information 44a is attribute information which relates to the user. A plurality of attributes are included in the user information 44a such as “name”, “date of birth”, “employee number”, “division and department”, “mail address”, “telephone number”, and the like in addition to “user ID” and “password” which are keywords for searching. The security information 44b is control information for restricting the use of the user information 44a as the password. The security information 44b is set by the IT manager. Here, details of the security information 44b will be described later.

Next, a security securing method in the image forming system of the embodiment will be described.

The password characters, for which inputting in the MFP 2 is prohibited, are set in advance and are stored in the storage device 22 of the MFP 2. For example, it is not possible to use % _ [ ] \ / , : ; * ? < > | ‘ “ # and the like which are set as prohibited characters. In addition, it is possible to also set a minimum number of input characters for the password.

In the embodiment, in addition to the prohibited characters which are registered in advance in the MFP 2 as the password, attribute information out of the user information 44a which is specified by the IT manager is configured so as not to be included in the password. The attribute information which is specified by the IT manager is referred to as restriction information (characters).

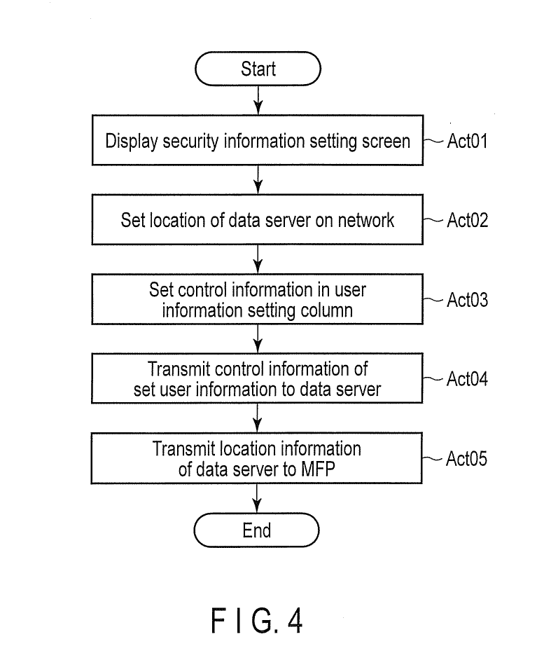

FIG. 4 is an exemplary flow diagram illustrating a sequence for changing and setting the security information 44b of the first embodiment.

In ACT 01, the IT manager displays a security information setting screen 34 in the display section 3b of the client terminal 3.

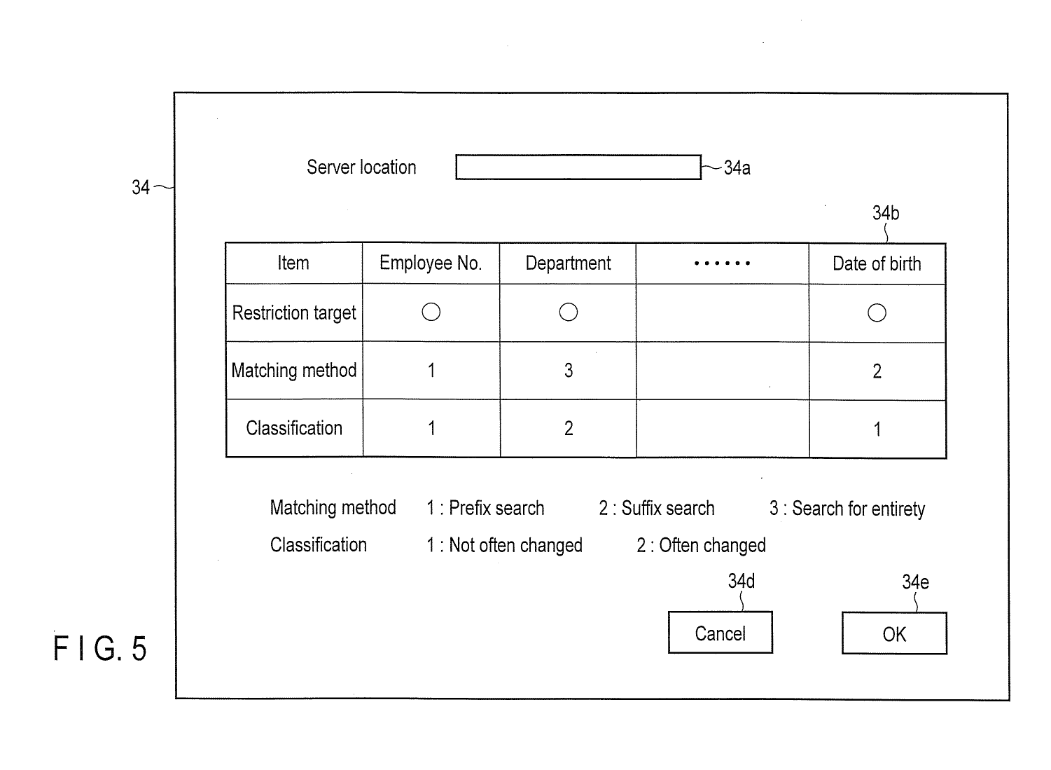

FIG. 5 is an exemplary diagram illustrating the security information setting screen 34 of the first embodiment.

In the security information setting screen 34, a server location input column 34a, a user information setting column 34b, a cancel button 34d, and an OK button 34e are provided.

An IP address (Internet Protocol address) or a FQDN (Fully Qualified Domain Name) is input as location information of the data server 4 on the network in the server location inputting column 34a.

In the user information setting column 34b, it is possible to set and input control information for each item of the user information 44a shown in FIG. 3. As the control information, the IT manager is able to set a sign in a “restriction target” column, a “matching method” column, or a “classification” column. When a specification sign is input in the “restriction target” column (for example, a O is input), the item of the specified user information 44a is dealt with as restricted characters. When numbers (1 to 3) are input in the “matching method” column, whether or not there are restricted characters is determined using the position of the characters which are included in the password in correspondence with the number which is input. When a number (=1) is input in the “matching method” column, it is determined to be a restricted character in a prefix search. When a number (=2) is input in the “matching method” column, it is determined as restricted characters in a suffix search. When a number (=3) is input in the “matching method” column, it is determined as restricted characters when searching for the entirety thereof.

For example, assume that the employee number is specified as a restriction target and the employee number of the user is 01234. In this case, when the matching method is set as the prefix search, the suffix search, or searching for the entirety thereof, for example, the passwords of 01234AAAXYZ, XYZAAA01234, 01234 are respectively prohibited.

A group number which classifies the items of the user information 44a is input in the “classification” column. For example, a group number (=1) is classification information as the user information 44a which is not often changed (employee number, date of birth, name, and the like). A group number (=2) is classification information as the user information 44a which is often changed (title, telephone number, department, division, and the like). A method which uses this “classification” will be described later.

When the cancel button 34d is pressed, the security information setting screen 34 is terminated without processing been performed. When the OK button 34e is pressed, the set information is transmitted to the MFP 2 and the data server 4.

In ACT 02 in FIG. 4, the IT manager sets the location information of the data server 4 on the network in the server location input column 34a. In ACT 03, the IT manager sets control information in the user information setting column 34b.

Then, when the IT manager presses the OK button 34e, in ACT 04, the control section 31 of the client terminal 3 transmits the control information of the set user information 44a to the data server 4 which is specified in the location information. The data server 4 stores the received control information in security information 44b of the user DB 44.

In ACT 05, the control section 31 transmits the location information of the data server 4 on the network to all of the MFPs 2. The MFPs 2 store the location information of the data server 4 which was transmitted in the storage device 22.

In addition, the IT manager sets a skip condition using the client terminal 3. The skip condition is a condition for giving a time delay when the user changes a password. The IT manager sets the delay period or date, or the number of skips for the change in password as the skip condition. When the password which is being used by a user does not meet the password policy which is set by the IT manager, it is necessary that the user changes the password within the scope (within the period) of the skip condition which is set by the IT manager.

The IT manager displays a skip condition setting screen 36 in the display section 3b of the client terminal 3.

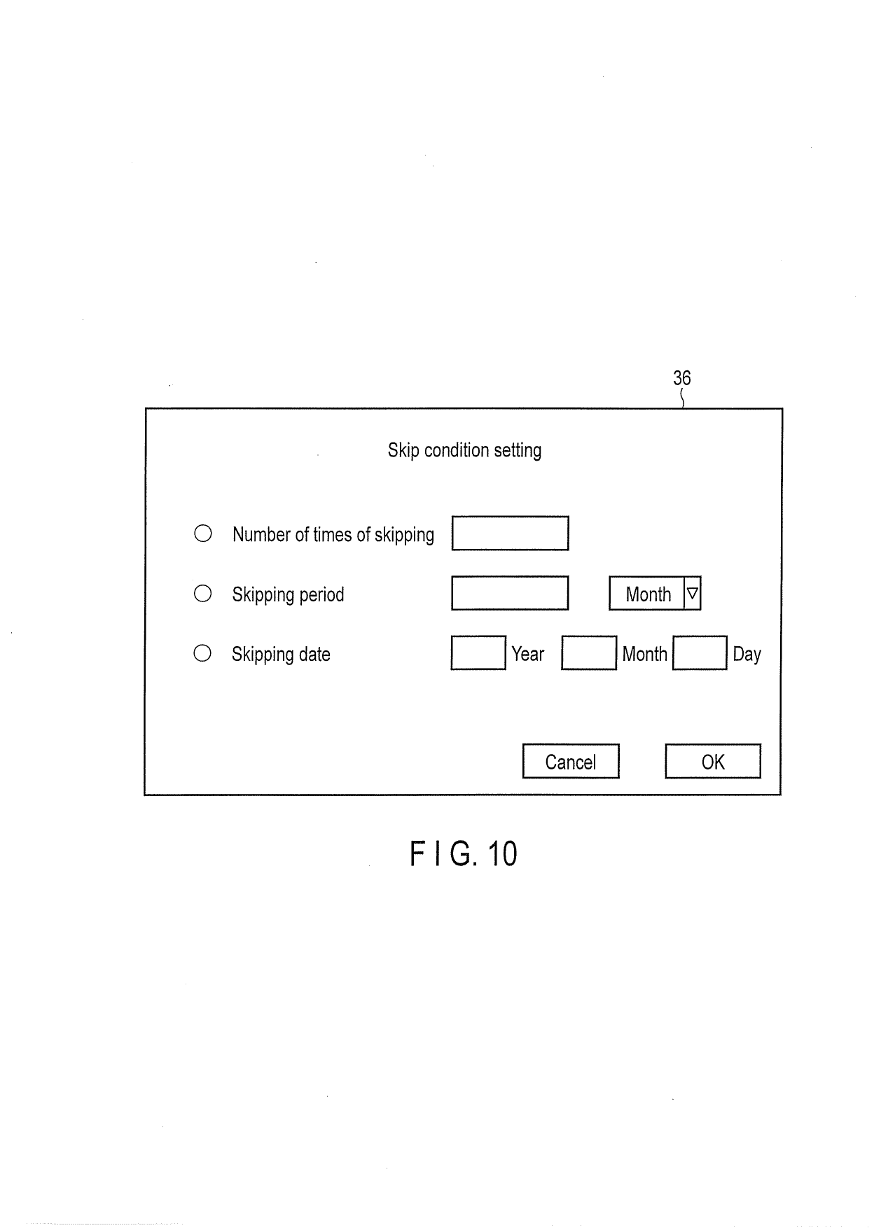

FIG. 10 is an exemplary diagram illustrating the skip condition setting screen of the first embodiment.

By a number of skips being selected using a radio button and a number N being set in the input column, it is possible that a change in password is not requested until N times. By a skip period being selected using a radio button and a period being set in the input column, it is possible that a change in password is not requested until the period has passed. It is possible that the period is selected with days, weeks, or months as a unit. By a skip date being selected using a radio button and a date being set in the input column, it is possible that a change in password is not requested until the date has passed.

When the IT manager sets the skip condition and presses the OK button, the set content is transmitted to the data server 4. The data server 4 stores the received skip condition to the security information 44b of the user DB 44.

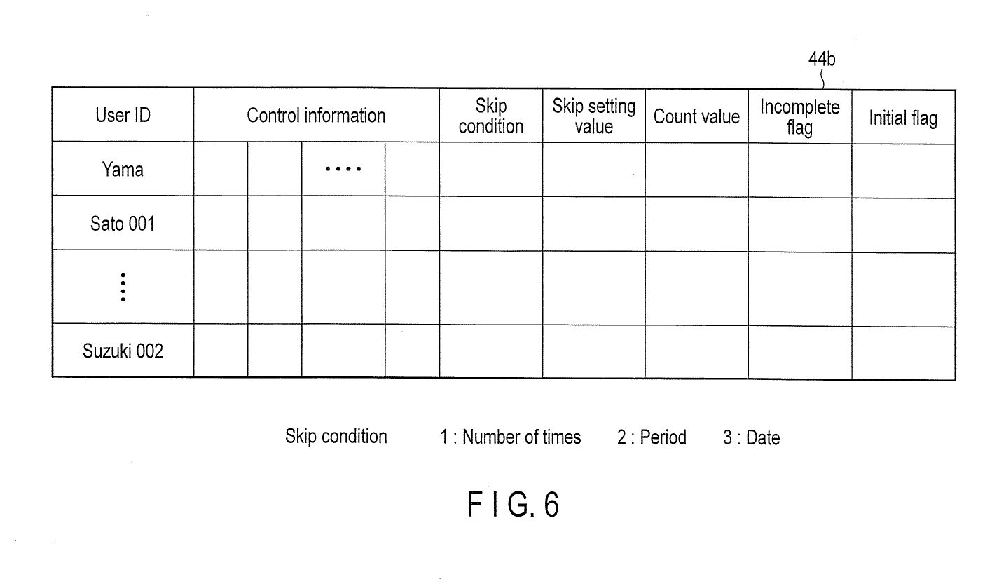

FIG. 6 is an exemplary diagram illustrating the content of the security information 44b in the user DB 44 of the first embodiment.

The security information 44b includes “control information”, “skip condition”, “skip setting value”, “count value”, “incomplete flag”, and “initial flag” for each user ID. The “control information” is information which is set by the IT manager and is transmitted from the client terminal 3. The “skip condition” is a value which indicates whether or not the IT manager has provided a delay (number of times, period, or the like) in the change of password, and for example, number of times (=1), period (=2), or date (=3) is stored. The “skip setting value” is a value which represents the content of the delay described above, and the number of times or date which is set is stored. At this time, when the “skip condition” is period, a date which is calculated from the set period is stored in the “skip setting value”. The “count value” is an actual value which indicates how many times the user has logged in up until now when the delay described above is number of times. The “incomplete flag” is a value which represents whether or not a password updated by the IT manager is adopted. The “initial flag” is a flag for determining whether it is a first login after a predetermined event (for example, after the password is updated by the IT manager).

The control section 41 of the data server 4 stores the control information and the skip condition received from the client terminal 3 in the security information 44b with regard to all user IDs. Then, the control section 41 resets the “count value” to an initial value and sets the “incomplete flag” and the “initial flag” (=1).

Next, an operation where the MFP 2 changes the password after the IT manager updates the security information 44b will be described.

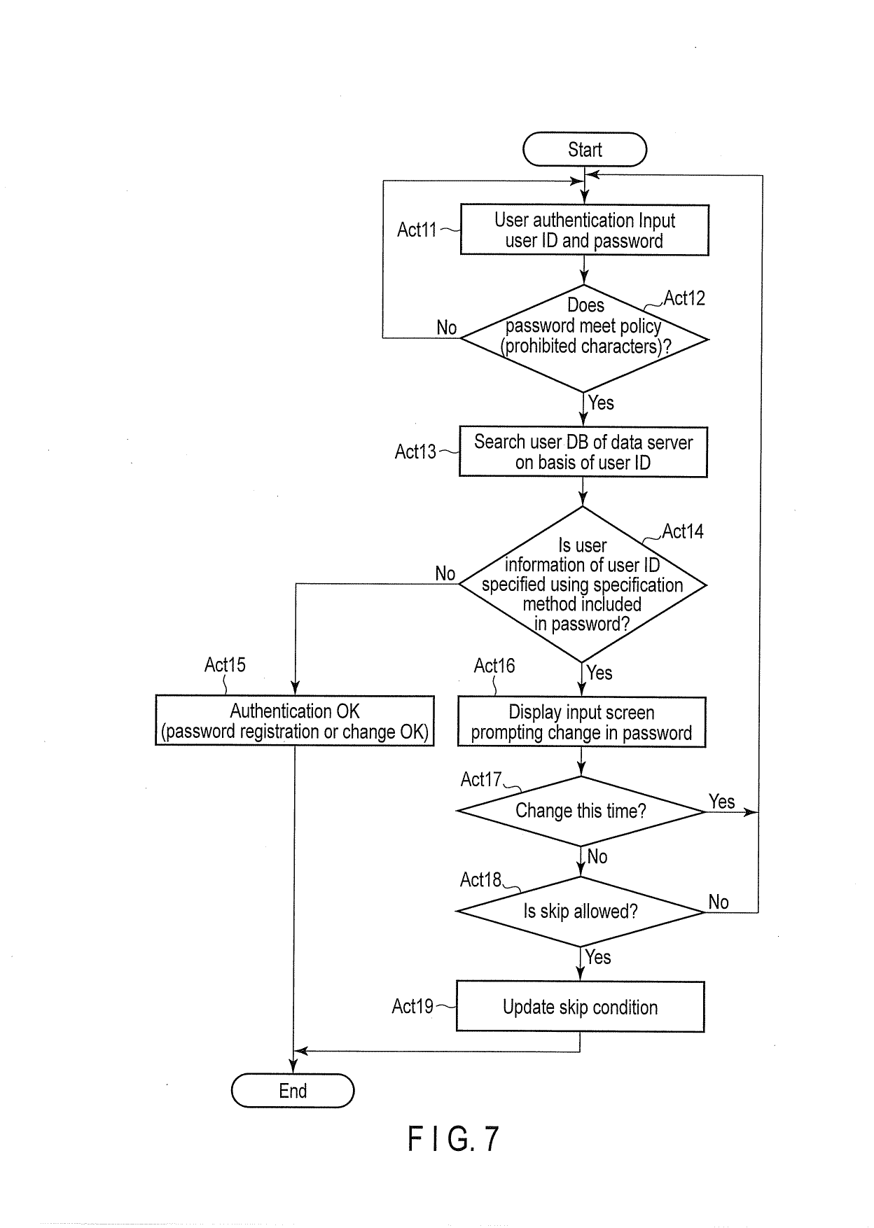

FIG. 7 is an exemplary flow diagram illustrating an initial authentication sequence after an update in the security information 44b in an image forming apparatus of the first embodiment.

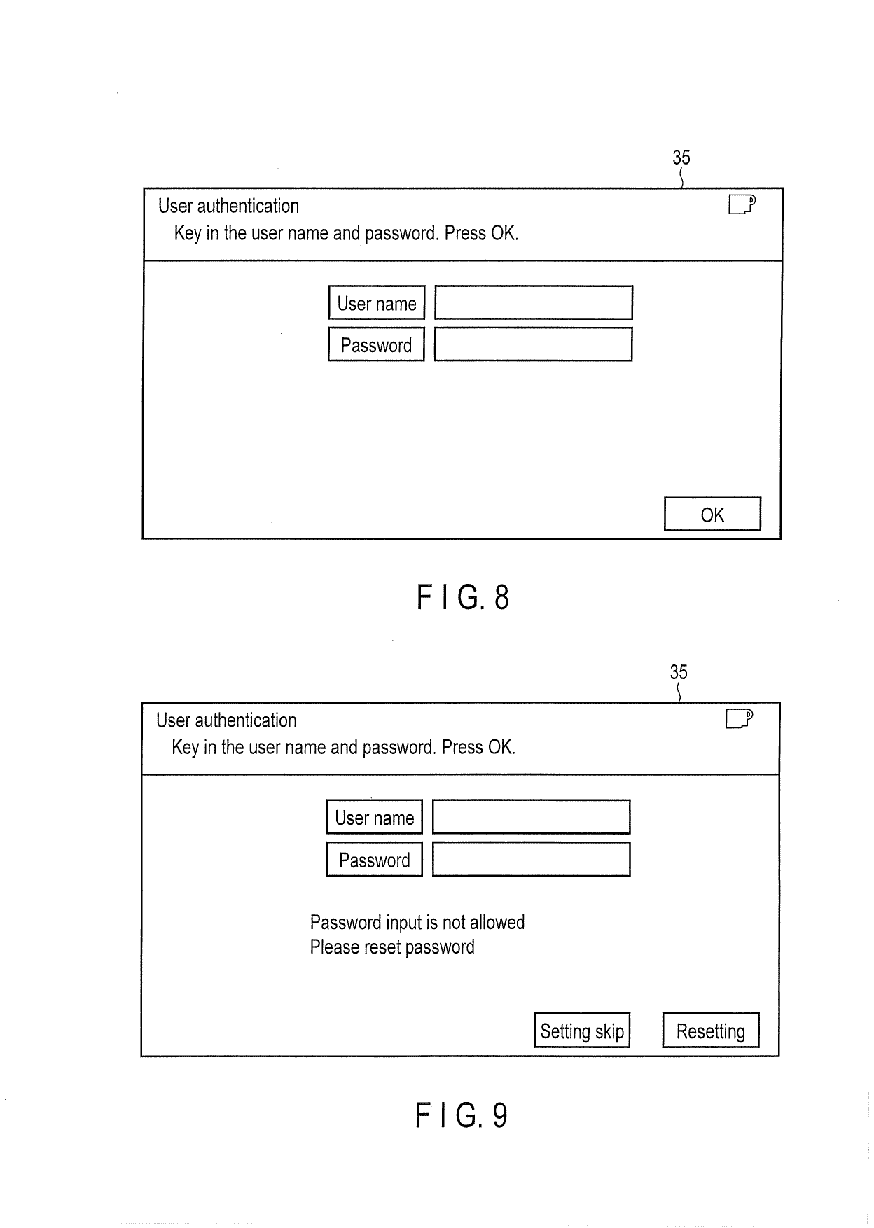

When using the MFP 2, the user starts a login operation from the control panel 2a. In ACT 11, the processing section 21c displays an authentication input screen 35 shown in FIG. 8 in the control panel 2a. The user inputs a user name and a password in the authentication input screen 35 and presses an OK button.

In ACT 12, the processing section 21c performs a check whether or not prohibited characteristics are included in the password input when the user logs in. The prohibited characters are registered in advance as described above and are stored in the storage device 22.

When the password input includes the prohibited characters (No in ACT 12), the inputting of the user name and the password again is requested by returning to ACT 11. When the password input does not include the prohibited characters (Yes in ACT 12), the user DB 44 of the data server 4 is searched in ACT 13 on the basis of the user ID. Then, the item of the user information 44a which is specified by the “restriction target” in the security information 44b and the “matching method” of the security information 44b are obtained.

In ACT 14, it is investigated whether or not the item of the user information 44a which is specified by the “restriction target” is included in the password input in the form which is specified in the “matching method”. When the password input meets the policy which is set by the IT manager (No in ACT 14), authentication is OK in ACT 15. That is, the password input is stored in the storage device 22 of the MFP 2. In addition, the password input is stored as the “password” of the user ID which is in the user information 44a of the data server 4 and the “incomplete flag” and the “initial flag” of the security information 44b are reset (=0).

When the password input does not meet the policy which is set by the IT manager (Yes in ACT 14), in ACT 16, the processing section 21c displays a message shown in FIG. 9 which prompts a change of password in the authentication input screen 35.

When the user changes and inputs the password and presses a resetting button (Yes in ACT 17), a process from ACT 11 and beyond is executed again based on the changed password.

When the user presses a setting skip button (No in ACT 17), in ACT 18, the processing section 21c references the security information 44b of the data server 4 and investigates whether or not a skip is to be allowed. For example, when the number of times, the period, or the date which was set is not yet been exceeded, it is within the delay period and the skip is allowed.

When the skip is not allowed, this is displayed on the authentication input screen 35, and when the user changes and inputs the password and presses a resetting button (No in ACT 18), a process from ACT 11 and beyond is executed again based on the changed password.

When the skip is allowed (Yes in ACT 18), the data in the server is updated in ACT 19. That is, one is added to the “count value” in the security information 44b and the “initial flag” is reset (=0). In addition, at this time, the set skip condition (number of time, date, or the like which is the delay) is displayed in the authentication input screen 35 and the user is made aware of this.

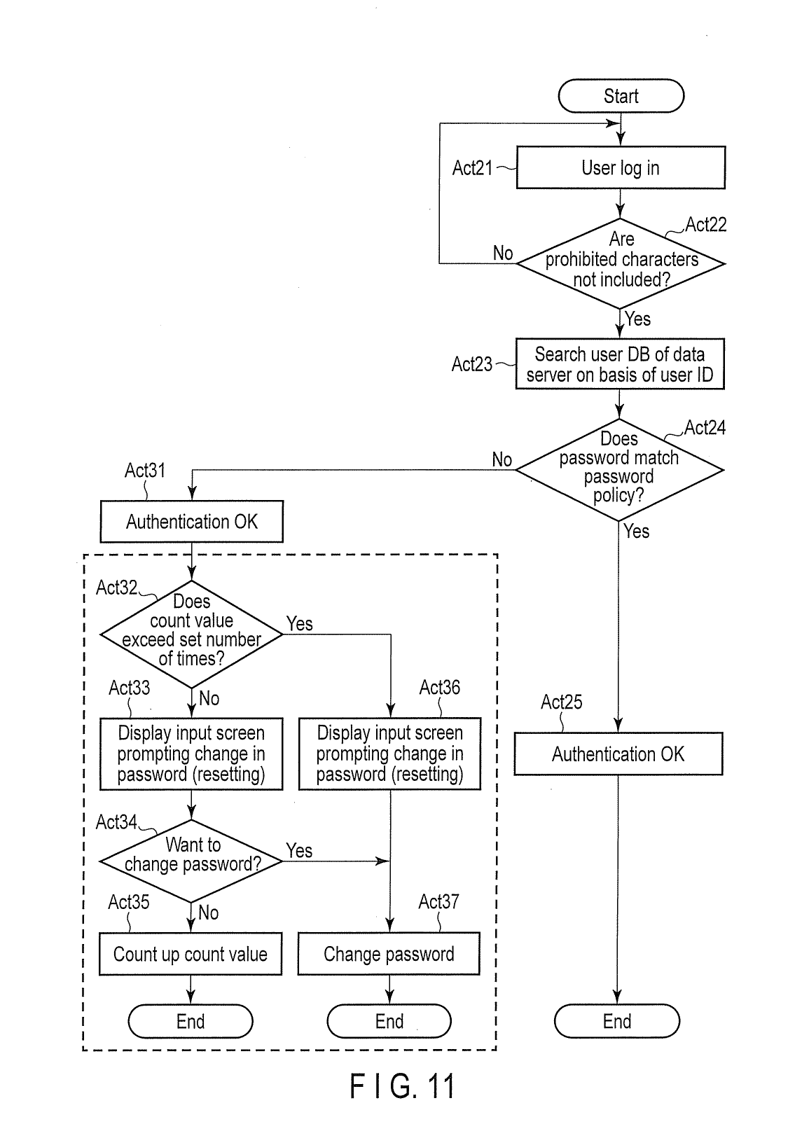

FIG. 11 is an exemplary flow diagram illustrating an authentication sequence of the second time and beyond after an update in the security information 44b in the image forming apparatus of the first embodiment. In this flow diagram, a case where the skip condition is a number of times is dealt with.

Since the processes of ACTs 21 to 23 are the same as the processes of ACTs 11 to 13 in FIG. 7, the details of the description are omitted. Here, when logging in for a second time or beyond, the “initial flag” of the user ID which is in the security information 44b of the data server 4 is reset (=0).

In ACT 24, it is investigated whether the item of the user information 44a specified in the “restriction target” is included in the password input in the form specified in the “matching method”. When the password input meets the policy (Yes in ACT 24), authentication is OK in ACT 25.

When the password input does not meet the policy which is set by the IT manager (No in ACT 24), authentication is OK in ACT 31. In ACT 32, whether or not the count value has exceeded the skip setting value is investigated. When the count value does not exceed the skip setting value (No in ACT 32), in ACT 33, an input screen which prompts a change of password is displayed in the control panel 2a. The input screen is the same as the authentication input screen 35 shown in FIG. 9.

When the user presses the setting skip button (No in ACT 34), in ACT 35, the processing section 21c adds one to the count value and counts up and executes the following processes. Here, when the setting skip button is pressed, a message of “please change your password before having logged in X times” is displayed on the screen.

When the user presses the resetting button (Yes in ACT 34), a process for changing the password is executed in ACT 37. Here, since the process for changing the password is described in FIG. 7, a repeat of the description will be omitted.

When the count value exceeds the skip setting value (Yes in ACT 32), an input screen which prompts a change of password is displayed in the control panel 2a in ACT 36. The input screen is provided with a resetting button in the authentication input screen 35 shown in FIG. 9 and a setting skip button is not displayed. When the user presses the resetting button, a process for changing the password is executed in ACT 37. Here, since the process for changing the password is described in FIG. 7, a repeat of the description will be omitted.

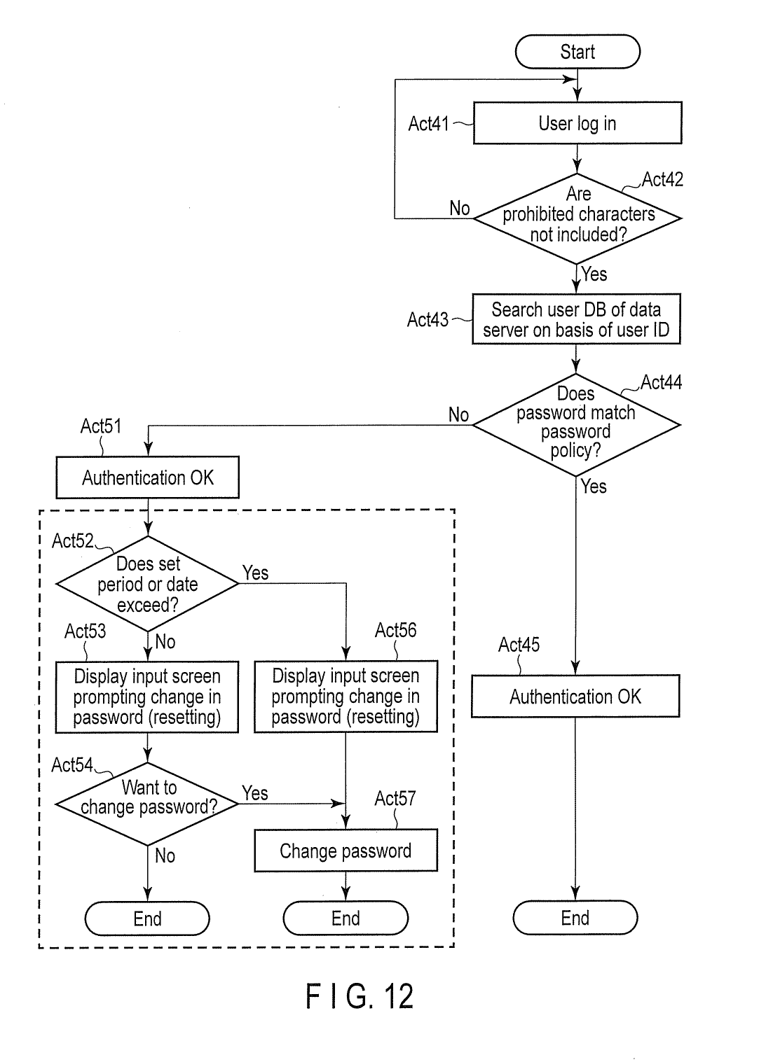

FIG. 12 is an exemplary flow diagram illustrating an authentication sequence of the second time and beyond after an update in the security information 44b in an image forming apparatus of the first embodiment. In this flow diagram, a case where the skip condition is a period or a date is dealt with.

Since the processes of ACTs 41 to 45 are the same as the processes of ACTs 21 to 25 in FIG. 11, the details of the description are omitted. Here, when logging in for a second time or beyond, the “initial flag” of the user ID which is in the security information 44b of the data server 4 is reset (=0).

When the password input does not meet the policy which was set by the IT manager (No in ACT 44), authentication is OK in ACT 51. In ACT 52, whether or not the current month and day exceed the month and day which is the skip setting value is investigated. When the current month and day do not exceed the month and day which is the skip setting value (No in ACT 52), in ACT 53, an input screen which prompts a change of password is displayed in the control panel 2a. The input screen is the same as the authentication input screen 35 shown in FIG. 9.

When the user presses the setting skip button (No in ACT 54), the following processes are executed. Here, when the setting skip button is pressed, a message of “please change your password within X days, within X months, or by X month and X day” is displayed on the screen.

When the user presses the resetting button (Yes in ACT 54), a process for changing the password is executed in ACT 57. Here, since the process for changing the password is described in FIG. 7, a repeat of the description will be omitted.

When the current month and day have exceeded the skip setting value (Yes in ACT 52), an input screen which prompts a change of password is displayed in the control panel 2a in ACT 56. The input screen is provided with a resetting button in the authentication input screen 35 shown in FIG. 9 and a setting skip button is not displayed. When the user presses the resetting button, a process for changing the password is executed in ACT 57. Here, since the process for changing the password is described in FIG. 7, a repeat of the description will be omitted.

Above, the first embodiment is described, but it is possible to configure the MFP 2 in a variation form which appropriately modifies the content which was described in the embodiment described above.

### Variation 1 of First Embodiment

In the embodiment described above, the function described below was described.

(1) Checking whether or not the password input satisfies the restriction condition which is set by the IT manager is performed when the user logs in and a change of password is prompted when the restriction condition is not met.

(2) When the IT manager changes the attributes which are restricted, checking of passwords is performed when each user performs a first login after the change and a change of password is prompted when the restriction, condition is not met.

The following variation in function may be provided with regard to the form.

(3) The manager sets an arbitrary period of time, checking of passwords is performed when each user performs a first login after the set period of time is passed, and a change of password is prompted when the restriction condition is not met. It is possible for this process to be realized with a configuration using the “initial flag” of the security information 44b.

(4) The user information 44a which is managed by the data server is divided into attribute information which do not often changes (employee number, date of birth, name, and the like) and attribute information which often changes (title, phone number, department, division, and the like). When there is a change of restriction in the attribute of the attribute group which often changes, checking of passwords is performed when each user performs a first login for each user after the change, and a change of password is prompted when the restriction condition is not met. It is possible for this process to be realized with a configuration using the “classification” in the “control information” and the “initial flag” of the security information 44b.

Then, it may be the case that checking of passwords is performed when each user performs a first login for each user using a condition where (2) and (3) are combined and a condition where (2) and (4) are combined and a change of password is prompted when the restriction condition is not met.

### Variation 2 of First Embodiment

When the IT manager changes the restriction condition, the changed content may be displayed in the control panel 2a of the MFP 2. Alternatively, the user which uses the MFP 2 may be notified of the content of the restriction changed using a mail from the MFP 2 or the data server 4. Due to this, it is possible to provide a period where the user prepares a password which is changed.

### Variation 3 of First Embodiment

After the IT manager changes the restriction condition, whether or not it is a first login after the change is checked when the user logs in. If it is the first login of the user, whether the password of the user meets the restriction condition is confirmed, and when it is met, authentication is OK and it is possible to log in.

After this, when the restriction is not changed, checking whether the password meets the restriction condition is not performed even if the user logs in. In addition, if the password is changed and the restriction condition is met, after this, when the restriction condition is not changed, checking whether the password meets the restriction condition is not performed, even if the user logs in.

Due to this, it is sufficient if a password check is not performed each time and it is possible to perform efficient password checking.

Here, in each of the embodiments described above, there is a configuration where it is possible to support a case where the user uses a plurality of MFPs 2 by the security information 44b for management being held on the data server 4. However, the security information 44b may be held in the MFP 2 depending on the relationship between the user and the MFP 2 which is being used.

According to each of the embodiments described above, it is possible for the image forming apparatus to follow the security policy which is conceived by the IT manager (company) in a timely manner. Accordingly, it is possible to flexibly and reliably operate the security policy.

Here, each of the functions described in the embodiments described above may be configured using hardware or may be realized by a program which has each of the functions being read out by a computer using software. In addition, each of the functions may have a configuration where either software or hardware is appropriately selected. Furthermore, it is possible to realize each of the functions by a program which is stored on a recording medium which is not shown being read out by a computer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus which is connected to a server via a communication line comprising:
a control section which obtains a user ID and a password for user authentication, receives a restriction condition which regulates a character string and a form thereof for which use as the password is prohibited from the server, determines whether or not the password input meets the restriction condition, and displays a screen which prompts a change in the password when the restriction condition is not met.

2. The apparatus according to claim 1,
wherein the restriction condition is that a character string, which is a predetermined item of information related to the user, is included in the password.

3. The apparatus according to claim 2,
wherein the control section determines whether or not the password input meets the restriction condition when initial authentication is performed with regard to the user after the restriction condition is changed and displays a screen which prompts a change in the password when the restriction condition is not met.

4. The apparatus according to claim 2,
wherein the control section determines whether or not the password input meets the restriction condition when an initial authentication is performed with regard to the user after a predetermined period has passed since a change in the restriction condition and displays a screen which prompts the change in the password when the restriction condition is not met.

5. The apparatus according to claim 2,
wherein the control section determines whether or not the password input meets the restriction condition when an initial authentication is performed with regard to the user after the restriction condition is changed with regard to an item of information where the frequency of changing is a predetermined value or more and displays a screen which prompts a change in the password when the restriction condition is not met.

6. The apparatus according to claim 2,
wherein the control section displays a module for having the user select a change in the password which is not executed until a predetermined condition is satisfied in a screen which prompts a change in the password.

7. The apparatus according to claim 6,
wherein the control section obtains a number of logins or a date which is stored in a server in advance as the predetermined condition from the server when the module is selected.

8. The apparatus according to claim 7,
wherein the control section does not execute a change in the password of the user when the predetermined condition is satisfied when the module is selected.

9. The apparatus according to claim 2,
wherein the control section displays a screen which represents that the restriction condition is changed or changed content after a change in the restriction condition.

10. An image forming method of an image forming apparatus which is connected to a server via a communication line comprising:
obtaining a user ID and a password for user authentication;
receiving a restriction condition which regulates a character string and a form thereof for which use as the password is prohibited from the server;
determining whether or not the password input meets the restriction condition; and
displaying a screen which prompts a change in the password when the restriction condition is not met.

11. The method according to claim 10,
wherein the restriction condition is that a character string, which is a predetermined item of information related to the user, is included in the password.

12. The method according to claim 11,
wherein the determining comprises determining whether or not the password input meets the restriction condition when initial authentication is performed with regard to the user after the restriction condition is changed.

13. The method according to claim 11,
wherein the determining comprises determining whether or not the password input meets the restriction condition when initial authentication is performed with regard to the user after a predetermined period has passed since a change in the restriction condition.

14. The method according to claim 11,
wherein the determining comprises determining whether or not the password input meets the restriction condition when an initial authentication is performed with regard to the user after the restriction condition is changed with regard to an item of information where the frequency of changing is a predetermined value or more.

15. The method according to claim 11, further comprising:
displaying a module for having the user select a change in the password which is not executed until a predetermined condition is satisfied in a screen which prompts a change in the password.

16. The method according to claim 15, further comprising:
obtaining a number of logins or a date which is stored in the server in advance as the predetermined condition from the server when the module is selected.

17. The method according to claim 16, further comprising:
not executing a change in the password of the user when the predetermined condition is satisfied when the module is selected.

18. The method according to claim 11, further comprising:
displaying a screen which represents that the restriction condition is changed or changed content after a change in the restriction condition.

19. An image forming system, which is provided with an image forming apparatus and a server which is connected to the image forming apparatus via a communication line,
the image forming apparatus obtaining a user ID and a password for user authentication and transmitting the user ID to the server,
the server transmitting a restriction condition, which is extracted based on the user ID and which regulates a character string for which use as the password is prohibited and a form thereof to the image forming apparatus, and
the image forming apparatus determining whether or not the password input meets the received restriction condition, and displaying a screen which prompts a change in the password when the restriction condition is not met.

20. The system according to claim 19,
wherein the restriction condition is that a character string, which is a predetermined item of information related to the user, is included in the password.
